(19) United States
(12) Patent Application Publication
(10) Pub. No.: US 2021/0189957 A1
(43) Pub. Date: Jun. 24, 2021

(54) SYSTEM FOR CONVERSION OF HEAT ENERGY INTO MECHANICAL POWER

(71) Applicant: Nikola Todorov KOLEV, Varna (BG)

(72) Inventor: Nikola Todorov KOLEV, Varna (BG)

(21) Appl. No.: 16/311,714

(22) PCT Filed: Oct. 1, 2018
(86) PCT No.: PCT/BG2018/000036

§ 371 Date: Dec. 20, 2018

(30) Foreign Application Priority Data
Sep. 3, 2018 (BG) 112798

(51) Int. Cl. F02C 6/12; F02C 6/00; F02C 6/20

(52) U.S. Cl. CPC F02C 6/12; F02C 6/00; F05D 2220/40; F05D 2220/32; F02C 6/20

(57) ABSTRACT

The system is used as a replacement of internal combustion engines in various fields of engineering, transferring heat energy by means of efficient units, equipment, and processes at reduced temperature and pressure that provides for increased efficiency at full oxidation and reduced CO₂ products, without toxic waste products. The said system also provides extreme power output and allows for driving an electric car when embodied in an electric vehicle.

It comprises at least one gas turbocharger (1-2, 6-7), and a combustion chamber (8) connected to a gas turbine (1) and to a mechanical module (17) configured as a cylinder block. The said system also comprises an electric compressor (11), an intake manifold (16) and an exhaust air manifold (21), as well as a control unit (24) and power supply unit (25). The mechanical module (17) is embodied as a cylinder block provided with a distributor plate (26), along the axis of which, in a cylindrical longitudinal duct, a distribution shaft (28) is installed such as to provide for its free rotation, with intake apertures (30) and venting apertures (31) being cut through in the said distribution shaft (28).

### FIELD OF THE INVENTION

The invention is related to a system for converting heat energy into mechanical power, which is applicable to all systems that consume power produced by carbon fuels combustion and replace internal combustion engines (ICE) in various fields of engineering.

### PRIOR ART

A major problem with internal combustion engines is the production of toxic oxides from burning of carbon fuels. The fuel burning process is not effective. The burning of carbon fuels is aggravated by the following more significant factors: the amount of molecules of CO₂ combustion product) is always less than the number of carbon atoms in the fuel molecules after oxidation; the time taken for the oxygen to connect to the molecules of carbon fuels is short, particles remain unburnt; the high temperatures and high pressures, at which the combustion process occurs, generate toxic oxides of nitrogen—NOₓ, and the small spaces, in which carburation and combustion occur, worsen the quality of the process of heat energy production. For the intake of larger amount of oxygen in the combustion chambers of internal combustion engines, filling compressors based on inertia, etc. are used. Charging more oxygen into the cylinders of internal combustion engines is the sole purpose of all modern changes aimed at increase in their power. All improvements to internal combustion engines have the task of improving carburation and combustion by blowing more air into the intake manifolds. Larger amounts of oxygen oxidize more molecules of carbon fuels forming CO₂, however, they do not change the conditions of carburation and the time needed for oxidation. Expensive catalysts are introduced to reduce the amount of toxic oxides. Partial solutions to lessen the consequences of this chronic flaw are applied. However, there still remain the chronic shortcomings of carburation and combustion in internal combustion engines which occur in small volumes over a short period of time at high temperatures and pressures because pressure at the end of the compression increases, and at the end of combustion the maximum pressure increases critically resulting in increased losses due to friction and the need to enhance the strength of the construction also increases.

Ancillary equipment for cooling, distribution and fuel injection consumes power and reduces the efficiency of internal combustion engines. At present, the norms of minimum toxic products released during running of the internal combustion engines are not met and this is why the ban on their manufacture and use is demanded. There is a great need to replace the power units running on internal combustion engines with other rational systems to achieve 98-99% oxidation of carbon fuels forming CO₂, without the release of toxic waste and to reduce fuel consumption per unit of power.

A hybrid engine equipped with combustion chamber is known [1], which by its technical nature is a system for converting heat energy into mechanical power. The known system for converting thermal energy into mechanical power comprises a combustion chamber, the outlet of which is connected to the gas turbine inlet of a main gas turbocharger and the outlet of the gas turbine of the main gas turbocharger is connected to a second gas turbine. The outlet of the centrifugal compressor of the main gas turbocharger is connected to a mechanical module embodied in an internal combustion engine. The centrifugal compressor of the main gas turbocharger is also connected to the combustion chamber. The turbine of the main gas turbocharger sends hot gases to the second turbine, which is mounted on a common shaft with a reduction gear. An electric motor, which is located on the output shaft, together with the second gas turbine, is connected via a belt to an electric generator, and the latter in its turn is connected to the crankshaft of the internal combustion engine.

The disadvantages of the known system are increased fuel consumption due to the constantly operating internal combustion engine and significant amount of toxic waste products since air is let in the combustion chamber, together with the waste gases from the running internal combustion engine, which is the reason for low efficiency. The system is made up of a large number of cooling, distribution and fuel injection equipment and units that consume power, which further reduces the system's efficiency.

### SUMMARY OF THE INVENTION

The aim of the invention is to create a system for converting heat energy into mechanical power that provides reduced fuel consumption, low CO₂ emissions without toxic waste products, and that has an increased efficiency and is capable of being introduced into new production as well as incorporated into reconstruction of internal combustion engines already in use in all fields of the art.

This task is solved by a system for converting heat energy into mechanical power, which system comprises a combustion chamber, the outlet of which is connected to the inlet of a gas turbine of a main gas turbocharger; and the outlet of the gas turbine is connected to the inlet of a second gas turbine. The outlet of the centrifugal compressor of the main gas turbocharger is connected to a mechanical module. According to the invention, the connection of the centrifugal compressor to the mechanical module that is configured as a cylinder block is accomplished via consecutively connected a first pressure transducer, the fourth valve, an intake manifold and its corresponding branching to the volume of each cylinder of the cylinder block. The outlet of each cylinder is connected to an exhaust manifold, the outlet of which in its turn is connected via a second pressure transducer and via the fifth valve to the atmosphere. The outlet of the exhaust manifold is also connected to an inner pipe of an ejector, whose outer pipe is connected via the third valve to an electric compressor, whose outlet is connected simultaneously to the third valve as well as to the first valve and the latter is connected simultaneously via the second valve to the combustion chamber and via the intake manifold, via the corresponding branching of the intake manifold to the respective cylinder of the cylinder block. The second gas turbine is a part of a secondary gas turbocharger. The outlet of the secondary centrifugal compressor of the second gas turbocharger is connected to the ejector inlet. The combustion chamber is connected to a fuel tank through a dispenser and electrically to a sparking plug. The system also has a control unit connected to a power supply unit. The control unit is electrically connected to the fuel tank, dispenser, electric compressor, sparking plug, first, second, third, fourth and fifth valves as well as to the first and second pressure transducers. The cylinder block is provided with a distribution plate closing the cylinders of the cylinder block. Along the longitudinal axis of the distribution plate, a longitudinal horizontal cylindrical duct is cut through, in which a cylindrical distributor shaft is integrated in such a way allowing its free rotation. In the distribution plate, in the area above each of the cylinders, there is configured a pair of opposite transverse horizontal ducts for supplying air and for discharging the exhaust air, the axes of which ducts lie in one plane, parallel to one another, perpendicular to the longitudinal axis of the distribution plate and are offset one another at a distance. The ends of the transverse horizontal ducts for air intake and exhaust discharge are configured so as to form, respectively, air intake apertures and exhaust discharge apertures. The air intake aperture of each transverse horizontal duct is connected to the respective branching of the intake manifold supplying air to the cylinders, and the aperture for taking out the exhaust air of each transverse horizontal exhaust duct is connected to the exhaust manifold. In the distribution plate, beneath the distributor shaft and above each cylinder there is a vertical duct configured so as to serve both—as air supply duct and exhaust air duct. The distributor shaft is configured as a smooth cylinder along which, at a distance from each other and in the areas located above each cylinder, there are configured, respectively, an air inlet aperture and an exhaust outlet aperture that are cut along the diameter of the distributor shaft and displaced relative to each other so as to provide for intermittent and sequential connection of the respective cylinder to its corresponding horizontal transverse air intake duct through a vertical duct as well as to connect the cylinder to its respective horizontal transverse duct for discharging the exhaust through the vertical duct. The distributor shaft is driven by a crankshaft via a gear drive. Each air intake aperture on the distributor shaft is configured so as to provide connection of the intake manifold to the respective cylinder through the vertical duct when the piston has passed over top dead center by 2-3 degrees, and to close the the air intake aperture of the horizontal air intake duct before the piston has reached bottom dead center. Each exhaust outlet aperture is configured such, that before the piston has reached bottom dead center, it should be located opposite the aperture of the transverse horizontal duct for discharging the exhaust air to the exhaust manifold through the vertical duct.

An advantage of the invention is that the conversion of thermal energy into mechanical power is accomplished with high efficiency at reduced fuel consumption, reduced CO₂ emissions, without toxic waste due to the complete oxidation of the fuel in a permanent combustion process at efficient carburation with a high amount of oxygen. Another advantage of the system is its wide application, both in the reconstruction of the existing internal combustion engines for the production of mechanical power as well as in the manufacture of new power systems in different fields of the art. The advantage of the system, namely the high efficiency, is achieved by applying efficient units and equipment used to convert heat energy into mechanical power through the most efficient thermodynamic processes carried out in the system at low temperature and pressure of the energy carrier, i.e. the compressed air. The increase in efficiency is also due to the removal of units and equipment that are not needed for the system, such as cooling, air-fuel mixture distribution and fuel injection equipment.

### BRIEF DESCRIPTION OF THE DRAWINGS

The invention is explained with help of the attached figures, where:

FIG. 1 is a principle scheme illustrating the system for converting heat energy into mechanical power according to the invention;

FIG. 2 shows a side view of a mechanical module embodied in a cylinder block;

FIG. 3 shows an enlarged section along A-A of the cylinder block.

### DETAILED DISCRIPTION OF EMBODIMENT OF THE INVENTION

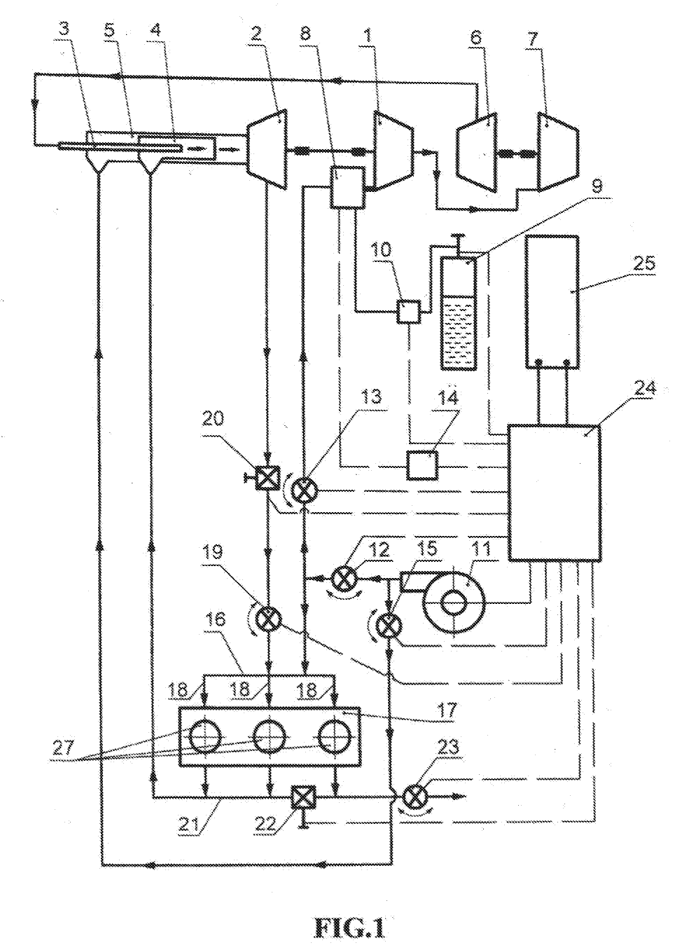

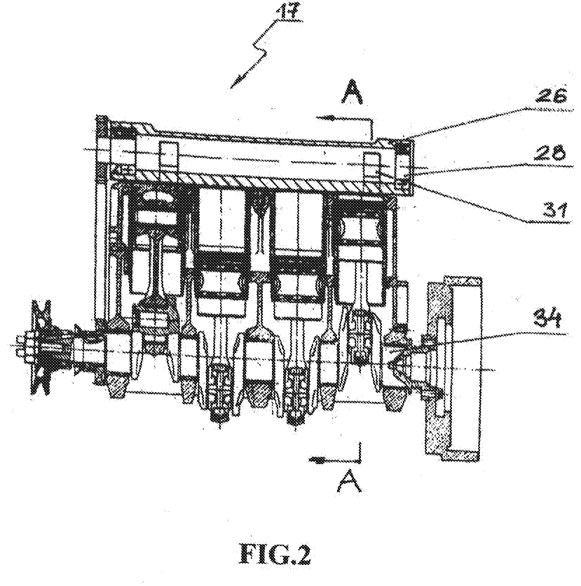

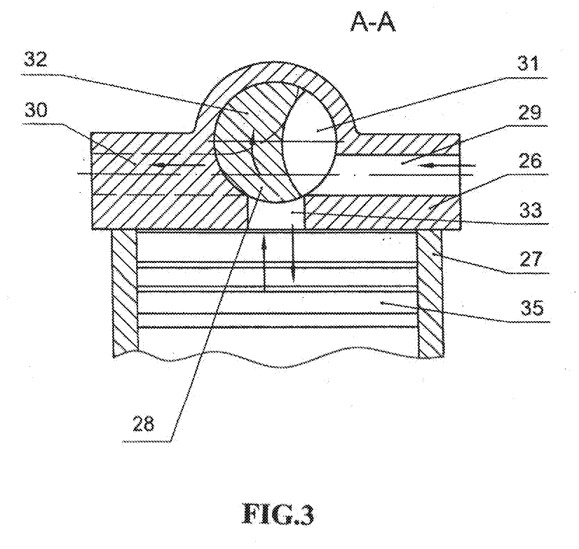

The system for converting heat energy into mechanical power according to the invention is shown in FIG. 1, in which the hydraulic connections are indicated by continuous lines and the electrical connections are indicated by broken lines. The said system comprises a main turbocharger with a gas turbine 1 connected mechanically to a centrifugal compressor 2. An ejector 3 is connected to the suction side of the centrifugal compressor 2. The ejector 3 is located in an inner pipe 4 enclosed by an outer pipe 5. The system also includes a secondary gas turbocharger with a second gas turbine 7 connected mechanically to a second centrifugal compressor 6. The inlet of the ejector 3 is connected to the outlet of the second centrifugal compressor 6 that is mechanically connected to the second gas turbine 7, whose inlet is connected to the outlet of the first gas turbine 1. The inlet of the first gas turbine 1 is connected to the outlet of a combustion chamber 8 that is connected to a fuel tank 9 through a dispenser 10. The system also comprises an electric compressor 11 whose outlet is connected simultaneously to the first valve 12 and to the third valve 15. The first valve 12 is simultaneously connected via the second valve 13 to the combustion chamber 8, and via the intake manifold 16 to its respective branchings 18. The outer pipe 5 of the ejector 3 is connected to the third valve 15. The combustion chamber 8 is electrically connected to the spark plug 14. The intake manifold 16 is joined to a mechanical unit 17 embodied in a cylinder block that is shown in FIGS. 2 and 3. A corresponding branching 18 of the intake manifold 16 is connected, respectively, to the volume of each cylinder 27 of the cylinder block 17. The outlet of the first centrifugal compressor 2 of the main gas turbocharger is connected via the fourth valve 19 and the first pressure transducer 20 to the intake manifold 16. The volumes of each cylinder 27 of the cylinder block 17 are connected to an outlet (exhaust) manifold 21, whose outlet is connected to the inner pipe 4 of the ejector 3. The outlet (exhaust) manifold 21 is provided with a second pressure transducer 22, the outlet of which is connected to the atmosphere through the fifth valve 23. The system also comprises a control unit 24, which is connected to a power supply unit 25 embodied in a battery. The control unit 24 is electrically separately connected to the fuel tank 9; the dispenser 10; the spark plug 14; to the first 12, the second 13, the third 15, the fourth 19 and the fifth 23 valves; to the first 20 and the second 22 pressure transducers; and to the electric compressor 11, indicated in FIG. 1 by broken lines.

The cylinder block 17 shown in FIGS. 2 and 3 is provided with a distribution plate 26 closing the cylinders 27 of the cylinder block 17. Along the longitudinal axis of the distribution plate 26, a longitudinal horizontal cylindrical duct is configured, where a distributor shaft 28 is installed such that it can freely rotate. In the distribution plate 26, in its area above each of the cylinders 27 (F IG. 3), there is a pair to each cylinder of opposite transversal horizontal air supply ducts 29 and exhaust outlet ducts 30, the axes of which lie in one and the same plane; they are parallel to each other, perpendicular to the longitudinal axis of the distribution plate 26, and are displaced to one another at a distance. The ends of the transverse horizontal air supply ducts 29 and the exhaust outlet ducts 30 are configured, respectively, as air intake apertures and exhaust outlet apertures. The air intake aperture of each transverse horizontal duct 29 is connected to the air intake manifold 16 supplying air to the cylinders 27. The exhaust outlet aperture of each transverse horizontal duct 30 is connected to the exhaust manifold 21. In the distribution plate 26, beneath the distributor shaft 28 and above each cylinder 27, a vertical duct 33 is configured serving both: as an air supply duct and an exhaust outlet duct. The distributor shaft 28 is embodied in a smooth cylinder, along the length of which at a distance from one another and in its areas located above each cylinder 27, there are configured an air supply aperture 31 and an exhaust outlet aperture 32, which are cut through along the diameter of the shaft 28 and are displaced relative to each other so as to provide for intermittent and sequential connection of the respective cylinder 27 to its respective horizontal transverse duct for air intake 29 through the vertical duct 33 as well as of its respective horizontal transverse duct for letting out the exhaust 30 to the vertical duct 33 for discharging the exhaust air from the cylinder 27. The distributor shaft 28 is driven by a crankshaft 34 by means of a gear drive at a ratio of 1:1. Each air intake aperture 31 of the distributor shaft 28 is configured such as to provide connection of the intake manifold 16 to the respective cylinder 27 through the vertical duct 33, when the piston 35 has passed over top dead center by 2 to 3 degrees, and to close the aperture of the horizontal air intake duct 29 before the piston 35 has reached bottom dead center. Each exhaust outlet aperture 32 is configured such that upon the piston 35 reaching a position before bottom dead center, it should be located opposite the aperture of the transverse horizontal duct 30 for taking the exhaust air to the outlet manifold 21 through the vertical duct 33.

In another embodiment of the inventio, when no extreme mechanical power is required, the secondary gas turbocharger comprising the second centrifugal compressor 6 and the second gas turbine 7 may be removed. Then, the inlet of the ejector 3 is connected to the atmosphere.

### USE OF THE INVENTION

The system can perform three separate operating modes: a start-up mode, a mode producing extreme mechanical power, and an electric vehicle mode.

The system is set into operation by an electric compressor 11, which charges compressed air through the first valve 12 via an air pipe, which is branched to the combustion chamber 8 via the second valve 13 and to the mechanical module 17 embodied as a cylinder block, through an intake manifold 16 and its branchings 18 to the volume of the cylinders 27. The crankshaft 34 of the mechanical module 17 is set in rotation and the combustion chamber 8 is filled with compressed air, whereupon the spark plug 14, the fuel tank 9 and the dispenser 10 are put into operation as well. The hot gases, by means of the first gas turbine 1 and the second gas turbine 7, set the wheels of the first centrifugal compressor 2 and the second centrifugal compressor 6 into rotation. Initially, the first centrifugal compressor 2 intakes air through the fifth valve 23, and after the secondary turbocharger has been rotated, it is filled with compressed air by the second centrifugal compressor 6 through the ejector 3, whereby the air pipe to the fourth valve 19 is charged by pressure and flow. The second centrifugal compressor 6 intakes air from the atmosphere. Upon reaching the designed pressure in the air pipe, the first pressure transducer 20 outputs a signal to the electronic unit 24 to open the fourth valve 19 and to shut off the electric compressor 11, to shut off the spark plug 14 and to close the first valve 12.

The air flow after the fourth valve 19 fills the intake manifold 16 whereby a portion of the flow is directed through the second valve 13 into the combustion chamber 8, and the other part enters the cylinders 27 through the branchings 18 when the piston 35 has passed over top dead center by 2-3 degrees. Before the piston 35 has reached bottom dead center, air discharge from the cylinder 27 begins into the exhaust manifold 21, where the second pressure transducer 22 and the fifth valve 23 are mounted by means of which pressure is applied to effect minimum power losses and to add flow to the first centrifugal compressor 2. If the pressure in the air pipe after the first centrifugal compressor 2 is less than the designed, the first transducer 20 sends a signal to the control unit 24 to switch on the electric compressor 11 and to open the first valve 12.

If the system is operating in the mode of producing extreme power according to the effective model, it needs a higher pressure of filling of the first centrifugal compressor 2 with compressed air, therefore, the electric compressor 11 is switched on. This is performed with the third valve 15 being opened, the first valve 12—closed, and with the air pipe set in operation to transfer the flow from the electric compressor 11 to the suction port of the first centrifugal compressor 2. The filling pressure of the first centrifugal compressor 2 is supplemented by the reduced pressure in the exhaust manifold 21 by transferring the air flow from the cylinder block 17 to the suction of the first centrifugal compressor 2. With the second centrifugal compressor 6 and the second gas turbine 7 arranged in cascaded disposition, and with the reuse of hot gases discharged from the first gas turbine 1, the filling pressure is increased. The air sucked by the second centrifugal compressor 6 is charged into the ejector 3. The flow jet of the second centrifugal compressor 6 via the ejector 3 sucks air from the outlet manifold 21. The system produces extreme power with the increase of the pressure at the outlet port of the first centrifugal compressor 2 by charging air by the electric compressor 11 with the first valve 12 being closed and the third valve 15 being opened via the air pipe to the outer pipe 5 of the ejector 3.

The system according to the invention can also be embodied in a vehicle driving mode as an electric car in an urban environment and where frequent brakings and various transitions are applied. In the vehicle electric mode, all units and valves are deactivated except for the electric compressor 11, the first valve 12 and the fifth valve 23. The electric vehicle mode is managed by the control unit 24 powered by the power supply unit 25, embodied as a battery. The control unit 24 supplies voltage to the electric compressor 11, the first valve 12 and the fifth valve 23. The compressed air produced by the electric compressor 11 is conveyed through the first valve 12 via the air pipe to the intake manifold 16 and through its respective branchings 18 enters the cylinders 27 of the cylinder block 17. The exhaust air is discharged into the exhaust manifold 21 and through the open valve 23 flows out into the atmosphere. The power produced by the cylinder block 17 is determined by the volume of the cylinders 27, the pressure of the compressed air produced by the electric compressor 11, and the speed of rotation of the distributor shaft 28 of the cylinder block 17. The traveled distance in electric vehicle driving mode is determined by the capacity of the battery 25, which is charged with the rotation of the crankshaft 34 of the cylinder block 17 and of the shaft of the battery charging electric generator 25 that is not shown in FIG. 1.

### CITED DOCUMENTS

1. U.S. Pat. No. 8,141,360

1. System for converting heat energy into mechanical power comprising a combustion chamber, the outlet of which is connected to the inlet of a gas turbine of a main gas turbocharger, and the outlet of the gas turbine of the main gas turbocharger is connected to a second gas turbine, as the outlet of the centrifugal compressor of the main gas turbocharger is connected to a mechanical module, characterized in that the coupling of the centrifugal compressor (2) to the mechanical module (17), the latter embodied as a cylinder block, is carried out via successively connected a first pressure transducer (20), a fourth valve (19), an intake manifold (16) and its corresponding branching (18) to the volume of each cylinder (27) of the cylinder block (17), and the outlet of each cylinder (27) is connected to an exhaust manifold (21), the outlet of the latter being connected via a second pressure transducer (22) and via a fifth valve (23) to the atmosphere, whereby the outlet of the exhaust manifold (21) is also connected to an internal pipe (4) of an ejector (3) whose outer pipe (5) is connected via a third valve (15) to an electric compressor (11), the outlet of which is connected simultaneously to the third valve (15) and to a first valve (12), which in its turn is connected simultaneously via a second valve (13) to a combustion chamber (8) and through the intake manifold (16) and the corresponding branching (18) of the intake manifold (16) to the respective cylinder (27) of the cylinder block (17), and a second gas turbine (7) is part of a secondary gas turbocharger, whereby the outlet of the second centrifugal compressor (6) of the secondary gas turbocharger is connected to the inlet of the ejector (3), and the combustion chamber (8) is connected to a fuel tank (9) via a dispenser (10) and electrically to a spark plug (14), whereby the system has also a control unit (24) powered by a power supply unit (25), as the control unit (24) is electrically connected to the fuel tank (9), dispenser (10), electric compressor (11), spark plug (14), first (12), second (13), third (15), fourth (19) and fifth (23) valves as well as to the first (20) and second (22) pressure transducers, as the cylinder block (17) being provided with a distributor plate (26) closing the cylinders (27) of the cylinder block (17), and along the longitudinal axis of the distributor plate (26), a longitudinal horizontal cylindrical duct is configured, in which duct a cylindrical distributor shaft (28) is built in such as to allow for its free rotation, and in the distributor plate (26) in the area above each of the cylinders (27), a pair of opposite transverse horizontal ducts is configured, respectively, for air intake (29) and for venting the exhaust air (30), the axes of which lie in one plane, parallel to one another, perpendicular to the longitudinal axis of the distributor plate (26) and offset relative to each other at a distance, as the ends of the transverse horizontal ducts for air intake (29) and for venting of the exhaust air (30) are respectively configured as air intake apertures and exhaust air outlet apertures, whereby the air intake aperture of each transverse horizontal duct (29) is connected to the corresponding branching (18) of the air intake manifold (16) of the cylinders (27), and the exhaust air outlet aperture of each transverse horizontal duct (30) is connected to the exhaust manifold (21), as in the distributor plate (26) under the distribution shaft (28) and above each cylinder (27), a vertical duct (33) is configured serving both for air intake and exhaust air venting, whereby the distribution shaft (28) is embodied as a smooth cylinder along which, at a distance from one another, and in its areas located above each cylinder (27), an air intake aperture (31) and an exhaust air outlet aperture (32) are configured respectively, the said apertures are cut through along the diameter of the distribution shaft (28) and displaced relative to each other so as to provide for intermittent and sequential connection of the respective cylinder (27) with its horizontal transverse air intake duct (29) through the vertical duct (33) as well as of the respective cylinder (27) with its horizontal transverse duct for venting the exhaust air (30) through the vertical duct (33), whereby the distribution shaft (28) is driven by a crankshaft (34) by a gear drive and each air intake aperture (31) of the distribution shaft (28) is configured such as to provide for the connection of the intake manifold (16) to the respective cylinder (27) through the vertical duct (33) when the piston (35) has passed over top dead center by 2-3 degrees, and to close the aperture of the horizontal air intake duct (29) before the piston (35) has reached bottom dead center, as each aperture for exhaust air venting (32) being configured such that upon the piston (35) reaching a position before bottom dead center, the said exhaust air venting aperture to be located opposite the aperture of the transverse horizontal duct (30) to vent the exhaust air to the exhaust manifold (21) through the vertical duct (33).
